(19) United States
(12) Patent Application Publication
(10) Pub. No.: US 2017/0234725 A1
(43) Pub. Date: Aug. 17, 2017

(54) SENSOR ELEMENT, METHOD OF MANUFACTURING SENSOR ELEMENT, SENSOR, ELECTRONIC APPARATUS, AND MOVING OBJECT

(71) Applicant: SEIKO EPSON CORPORATION, Tokyo (JP)

(72) Inventor: Fumio ICHIKAWA, Suwa-shi (JP)

(73) Assignee: SEIKO EPSON CORPORATION, Tokyo (JP)

(21) Appl. No.: 15/426,614

(22) Filed: Feb. 7, 2017

(30) Foreign Application Priority Data
Feb. 17, 2016 (JP) 2016-027688

(51) Int. Cl. G01H 11/00; G01C 19/5642

(52) U.S. Cl. CPC G01H 11/00; G01C 19/5642

(57) ABSTRACT

A gyro sensor element includes a base, driving vibrating arms, which extend from the base, have a first surface and a second surface located on an opposite side to the first surface, and make a driving vibration, and detecting vibrating arms, which extend from the base, have a third surface located on a same side as the first surface and a fourth surface located on an opposite side to the third surface, and vibrate in accordance with a physical quantity applied to the driving vibrating arms, wherein the driving vibrating arms have bottomed grooves on at least one of the first surface and the second surface, and driving electrodes disposed on inner surfaces of the bottomed grooves, and the detecting vibrating arms have through holes penetrating the detecting vibrating arms in a direction crossing the third surface and the fourth surface, and detecting electrodes disposed on at least a part of an inner wall surface of the through holes.

### BACKGROUND

1. Technical Field

The present invention relates to a sensor element, a method of manufacturing a sensor element, a sensor, an electronic apparatus, and a moving object.

2. Related Art

In the past, vibration elements and gyro sensor elements have been used in electronic apparatuses such as cellular phones or digital cameras, and moving objects such as cars. Due to the demands of an improvement in performance of these electronic apparatuses and moving objects, decrease in impedance and an improvement in detection sensitivity are also demanded for the vibration elements and the gyro sensor elements.

For example, in JP-A-2006-266784 (Document 1), there is disclosed the fact that a base, detection arms extending from the base on both sides, connection arms extending from the base on both sides, and drive arms extending from each of the connection arms toward vertical directions are provided, and bottomed grooves are provided to the drive arms and the detection arms formed from the obverse and reverse surfaces to thereby improve the electrical field efficiency, and thus, the reduction of the impedance (the CI value, the series equivalent resistance) of the gyro element, and an improvement in sensitivity are achieved.

Further, in JP-A-2015-179933 (Document 2), there is disclosed the fact that a base, a pair of drive arms extending from the base on one side, and a pair of detection arms extending from the base on the opposite side to the drive arms, and penetrating grooves are provided to the drive arms and the detection arms to thereby improve the electrical field efficiency, and thus, the reduction of the impedance (the CI value, the series equivalent resistance) of the gyro element, and an improvement in sensitivity are achieved.

However, in such a gyro element having the detection arm part provided with the bottomed grooves as described in Document 1 described above, in the case of, for example, forming the bottomed grooves using wet etching, the surface of the groove bottom part inevitably has a shape having an angle with a surface of the sensor element in a material in which etching rate anisotropy exists.

In such a shape, when exposing the groove bottom part of each of the detection arms in a photolithographic process for forming electrodes, diffused reflection of the light occurs in the part having the angle, and a wall part, which should not essentially be exposed, is irradiated with the light.

As a result, the resist on the inner wall part of each of the grooves is lost after the development, it is unachievable to form the electrode in the groove to have a desired shape, and there is a possibility that the deterioration of the sensitivity is incurred.

Further, in such a gyro element having the detection arm parts provided with the penetrating grooves as described in Document 2 described above, since the side wall part of the penetrating groove provided to the drive arm becomes thinner, the thermoelastic loss generated in the vibration increases. Therefore, the drive impedance increases, and there is a possibility that the power consumption increase.

### SUMMARY

An advantage of some aspects of the invention is to solve at least a part of the problems described above, and the invention can be implemented as the following forms or application examples.

### Application Example 1

A sensor element according to this application example includes a base, a driving vibrating arm, which extends from the base, has a first surface and a second surface located on an opposite side to the first surface, and makes a driving vibration, and a detecting vibrating arm, which extends from the base, has a third surface located on a same side as the first surface and a fourth surface located on an opposite side to the third surface, and vibrates in accordance with a physical quantity applied to the driving vibrating arm, the driving vibrating arm has a bottomed groove on at least one of the first surface and the second surface, and a driving electrode disposed on an inner surface of the bottomed groove, and the detecting vibrating arm has at least one through hole penetrating the detecting vibrating arm in a direction crossing the third surface and the fourth surface, and a detecting electrode disposed at least a part of an inner wall surface of the through hole.

According to this application example, by forming the bottomed groove on the driving vibrating arm, it is possible to improve the electrical field efficiency without incurring the increase in the thermoelastic loss, and decrease the drive impedance. Further, by forming the through hole in the detecting vibrating arm, the diffuse reflection of the light in the groove can be suppressed in the photolithography process when forming the electrodes, and thus, it is possible to form the electrodes to have the desired shapes, and it is possible to suppress the degradation of the sensitivity.

Therefore, it is possible to provide the sensor element reduced in power consumption and high in sensitivity.

### Application Example 2

In the sensor element according to the application example, it is preferable that the two or more through holes are disposed along a direction in which the detecting vibrating arm extends.

According to this application example, since the dimension (the longest diameter in the through hole) of the through hole formed on the detecting vibrating arm can be made smaller, it is possible to reduce the distortion generated in the detecting vibrating arm when an impact is applied to the sensor element. Therefore, in addition to the advantage described above, it is also possible to obtain the advantage of improving the impact resistance.

### Application Example 3

In the sensor element according to the application example, it is preferable that the two or more driving vibrating arms extend from one end of the base, and are arranged side by side in a planar view, and the two or more detecting vibrating arms extend from the other end located on an opposite side to the one end of the base, and are arranged side by side in the planar view.

According to this application example, it is possible to obtain the sensor element suppressing the increase in power consumption, and the degradation of the sensitivity.

### Application Example 4

In the sensor element according to the application example, it is preferable that the two or more driving vibrating arms extend from one end of the base, and are arranged side by side in a planar view, and that at least one detecting vibrating arm extends from the one end of the base, and is arranged side by side with the two or more driving vibrating arms in the planar view.

According to this application example, it is possible to obtain the sensor element suppressing the increase in power consumption, and the degradation of the sensitivity.

### Application Example 5

In the sensor element according to the application example, it is preferable that a vibration direction of the detecting vibrating arm is a direction crossing a direction of the driving vibration.

According to this application example, it is possible to obtain the sensor element suppressing the increase in power consumption, and the degradation of the sensitivity.

### Application Example 6

In the sensor element according to the application example, it is preferable that the driving vibrating arms include a first driving vibrating arm, a second driving vibrating arm, a third driving vibrating arm, and a fourth driving vibrating arm, the detecting vibrating arms include a first detecting vibrating arm and a second detecting vibrating arm, defining two directions perpendicular to each other as a first direction and a second direction, the base includes a support part, a first connecting part and a second connecting part respectively extending from both sides of the support part along the second direction, the first detecting vibrating arm and the second detecting vibrating arm respectively extend from both sides of the support part along the first direction, the first driving vibrating arm and the second driving vibrating arm respectively extend from both sides of the first connecting part along the first direction, and the third driving vibrating arm and the fourth driving vibrating arm respectively extend from both sides of the second connecting part along the first direction.

According to this application example, it is possible to obtain the sensor element suppressing the increase in power consumption, and the degradation of the sensitivity.

### Application Example 7

In the sensor element according to the application example, it is preferable that a direction of the driving vibration and a direction in which the detecting vibrating arm vibrates are each a direction along the second direction.

According to this application example, it is possible to obtain the sensor element suppressing the increase in power consumption, and the degradation of the sensitivity.

### Application Example 8

A method of manufacturing a sensor element according to this application example includes the steps of providing the sensor element including a base, a driving vibrating arm, which extends from the base, and has a first surface and a second surface located on an opposite side to the first surface, and a detecting vibrating arm, which extends from the base, vibrates in accordance with a physical quantity applied to the driving vibrating arm, and has a third surface located on a same side as the first surface and a fourth surface located on an opposite side to the third surface, wherein the driving vibrating arm has a bottomed groove on at least one of the first surface and the second surface, and the detecting vibrating arm has a through hole penetrating the detecting vibrating arm in a direction crossing the third surface and the fourth surface, preparing a substrate having an obverse surface and a reverse surface, forming the base, the driving vibrating arm, the detecting vibrating arm, and the through hole by dry etching, forming the bottomed groove by etching, and forming an electrode pattern on at least one of an inner wall surface of the through hole and an inner surface of the bottomed groove.

According to this application example, since such a process as to penetrate the substrate is performed using dry etching, the processing accuracy of the outer shape and the through holes is high, and it is possible to manufacture the sensor element suppressing the increase in power consumption and degradation of the sensitivity.

### Application Example 9

In method of manufacturing the sensor element according to the application example, it is preferable that the step of forming the bottomed groove is performed after the step of forming the base, the driving vibrating arm, the detecting vibrating arm, and the through hole, and the etching in the step of forming the bottomed groove is performed by wet etching.

According to this application example, since the groove not penetrating the vibrating arm is formed using the wet etching, in the case of attempting to form the grooves on the obverse surface and the reverse surface of the vibrating arm, it is possible to process the obverse surface and the reverse surface at the same time. Therefore, the manufacturing process becomes easy.

### Application Example 10

In method of manufacturing the sensor element according to the application example, it is preferable that the step of forming the base, the driving vibrating arm, the detecting vibrating arm, and the through hole is performed after the step of forming the bottomed groove, and the etching in the step of forming the bottomed groove is performed by dry etching.

According to this application example, since the formation of the outer shape, the through hole, and the bottomed groove is performed using the dry etching, the whole of the sensor element can accurately be processed. Therefore, it is possible to manufacture the sensor element small in variation of the characteristics.

### Application Example 11

A sensor according to this application example includes the sensor element according to any one of the application examples, an electronic component including a circuit adapted to drive the sensor element and a circuit adapted to detect a signal, and a package adapted to house the sensor element and the electronic component.

According to this application example, it is possible to obtain a sensor, for example, a physical quantity sensor such as a gyro sensor, equipped with the sensor element suppressing the increase in power consumption, and the degradation of the sensitivity.

### Application Example 12

An electronic apparatus according to this application example includes the sensor element according to any one of the application examples described above.

According to this application example, it is possible to obtain the electronic apparatus equipped with the sensor element suppressing the increase in power consumption, and the degradation of the sensitivity.

### Application Example 13

A moving object according to this application example includes the sensor element according to any one of the application examples described above.

According to this application example, it is possible to obtain the moving object equipped with the sensor element suppressing the increase in power consumption, and the degradation of the sensitivity.

### BRIEF DESCRIPTION OF THE DRAWINGS

The invention will be described with reference to the accompanying drawings, wherein like numbers reference like elements.

FIG. 1 is a plan view of a sensor element according to a first embodiment of the invention.

FIG. 2 is a cross-sectional view along the line A-A in FIG. 1.

FIG. 3 is a cross-sectional view along the line B-B in FIG. 1.

FIG. 4 is a cross-sectional view showing an electrode configuration of a detecting vibrating arm provided with bottomed grooves.

FIG. 5 is a cross-sectional view for explaining the motion of the light irradiating the detecting vibrating arm provided with the bottomed grooves.

FIG. 6 is a plan view showing a driving vibrating state of the sensor element according to the first embodiment of the invention.

FIG. 7 is a plan view showing a detecting vibrating state of the sensor element according to the first embodiment of the invention.

FIG. 8 is a flowchart related to a manufacturing method according to the first embodiment of the invention.

FIG. 9 is a flowchart related to a manufacturing method according to the first embodiment of the invention.

FIG. 10 is a plan view of a sensor element according to a second embodiment of the invention.

FIG. 11 is a plan view of a sensor element according to a third embodiment of the invention.

FIG. 12 is a plan view of a sensor element according to a fourth embodiment of the invention.

FIG. 13 is a cross-sectional view along the line C-C in FIG. 12.

FIG. 14 is a cross-sectional view showing an outline of a sensor equipped with the sensor element according to the present embodiment.

FIG. 15 is a perspective view showing a cellular phone as an electronic apparatus equipped with the sensor element according to the present embodiment.

FIG. 16 is a perspective view showing a car as a moving object equipped with the sensor element according to the present embodiment.

### DESCRIPTION OF EXEMPLARY EMBODIMENTS

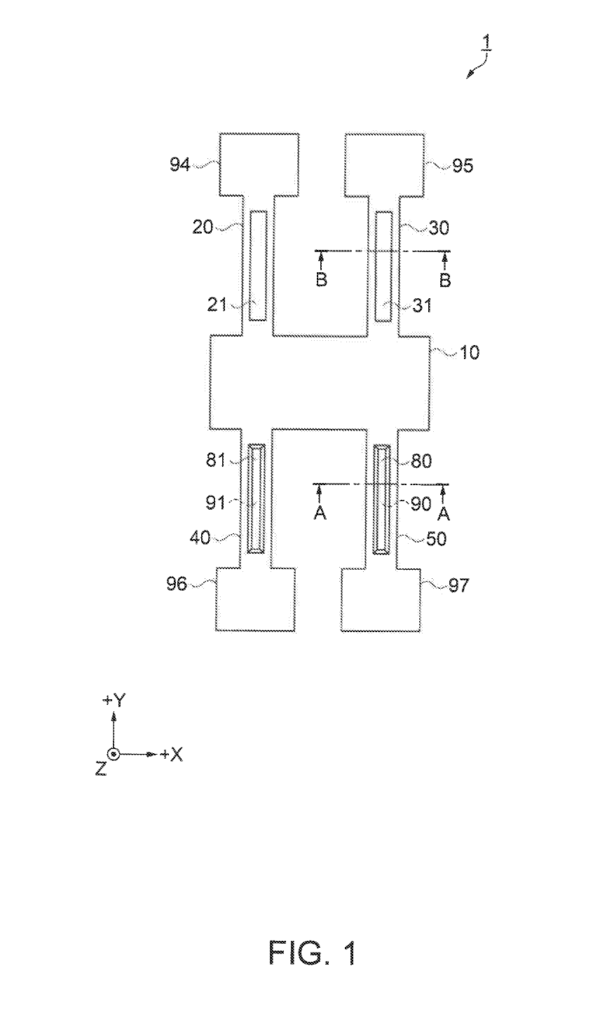

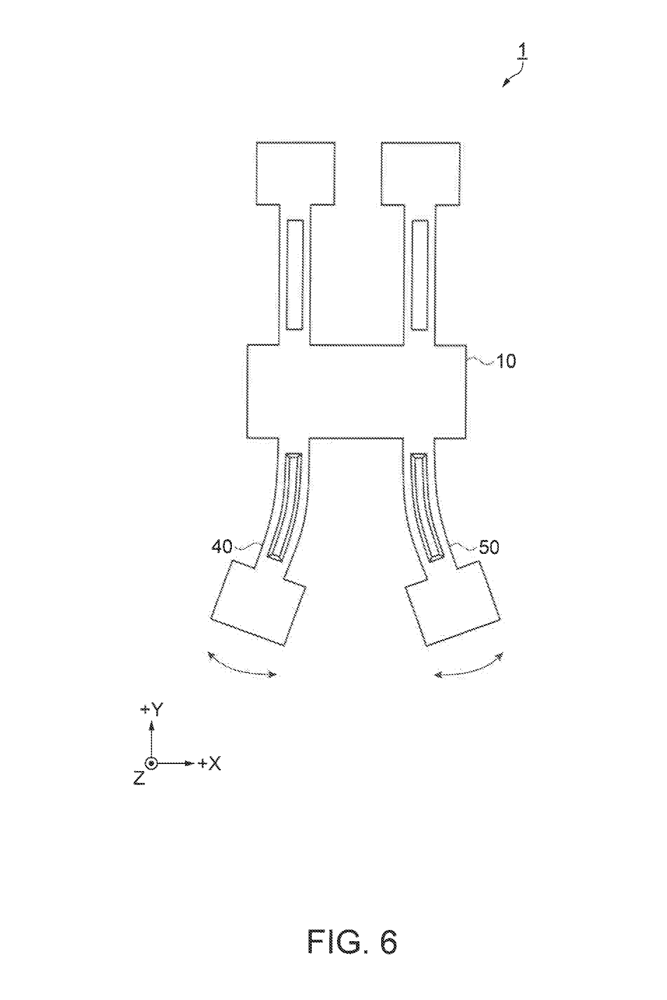

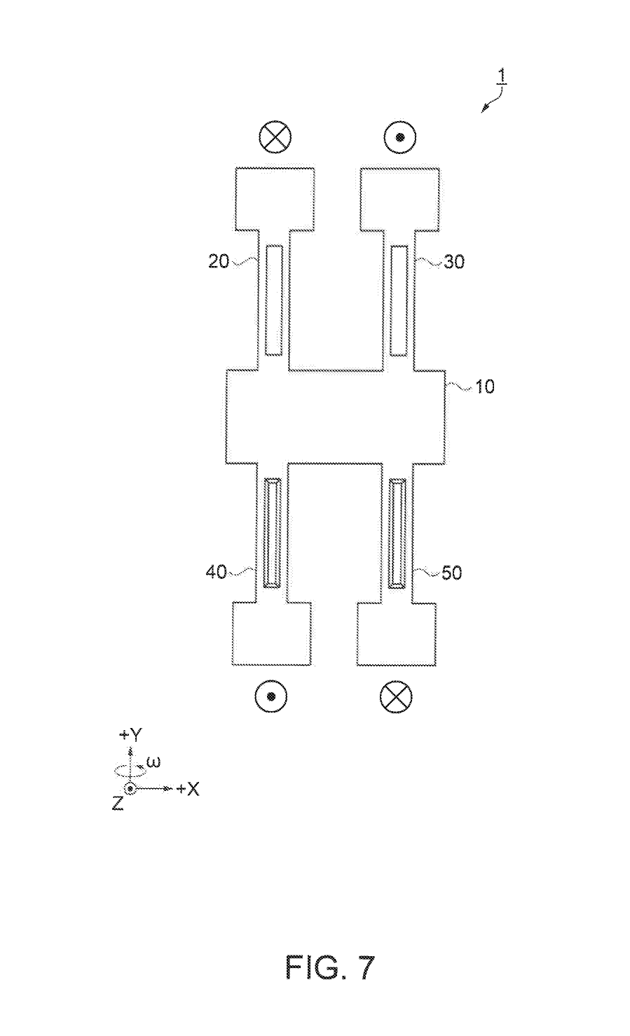

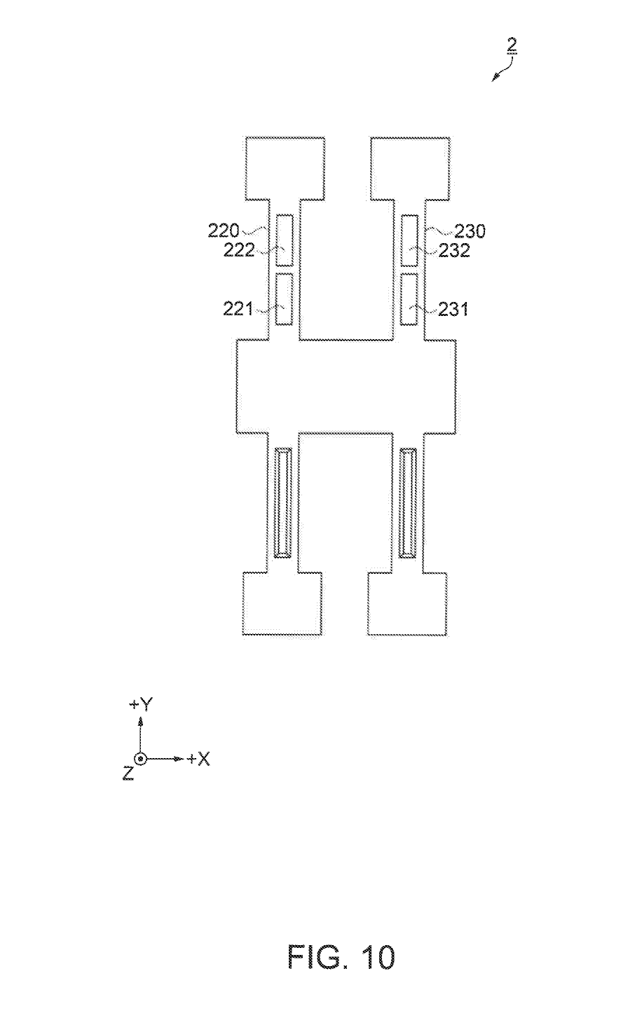

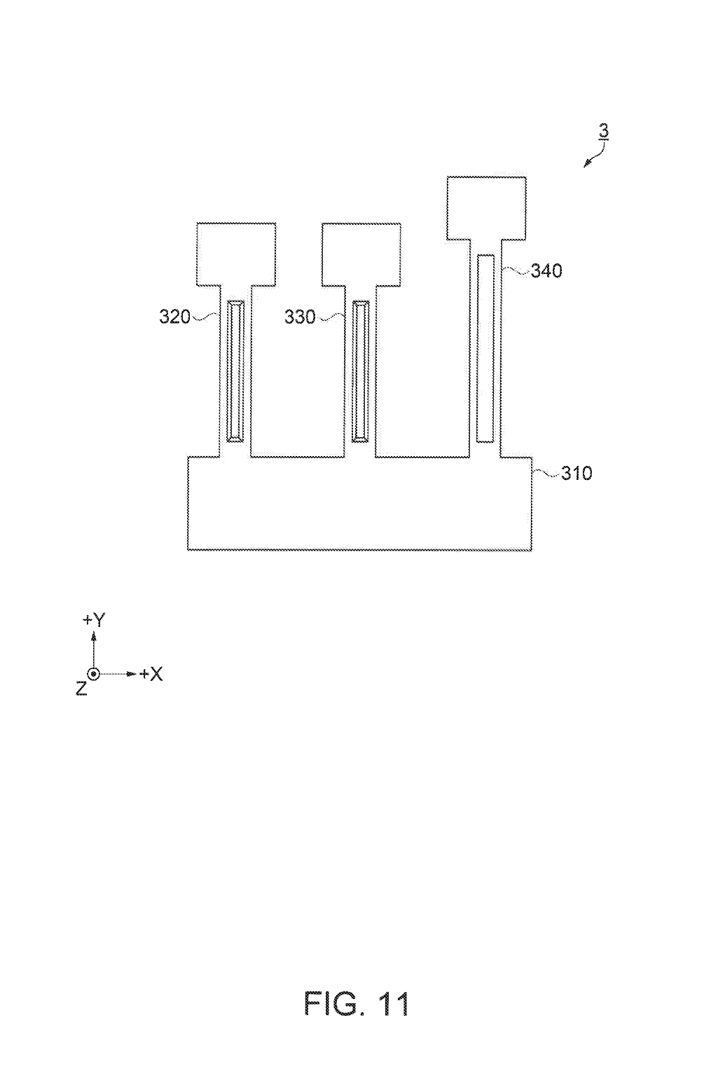

Some embodiments of the invention will hereinafter be described with reference to the accompanying drawings. It should be noted that in each of the drawings described below, the scale sizes of the layers and the members are made different from the actual dimensions in order to make the layers and the members have recognizable dimensions. Further, in FIG. 1 through FIG. 3, FIG. 6, FIG. 7, and FIG. 10 through FIG. 13, there are shown an X axis, a Y axis, and a Z axis as three axes perpendicular to each other, and the tip side of each of the arrows shown in the drawings is defined as “+side,” and the base end side is defined as “−side” for the sake of convenience of explanation. Further, in the following explanation, a direction parallel to the X axis is referred to as an “X-axis direction,” a direction parallel to the Y axis is referred to as a “Y-axis direction,” and a direction parallel to the Z axis is referred to as a “Z-axis direction.” Further, for the sake of convenience of explanation, the explanation will be presented assuming that a surface on the +Z-axis side is a first principal surface 60, and a surface on the −Z-axis side is a second principal surface 70 in a planar view viewed from the +Z-axis side.

### First Embodiment

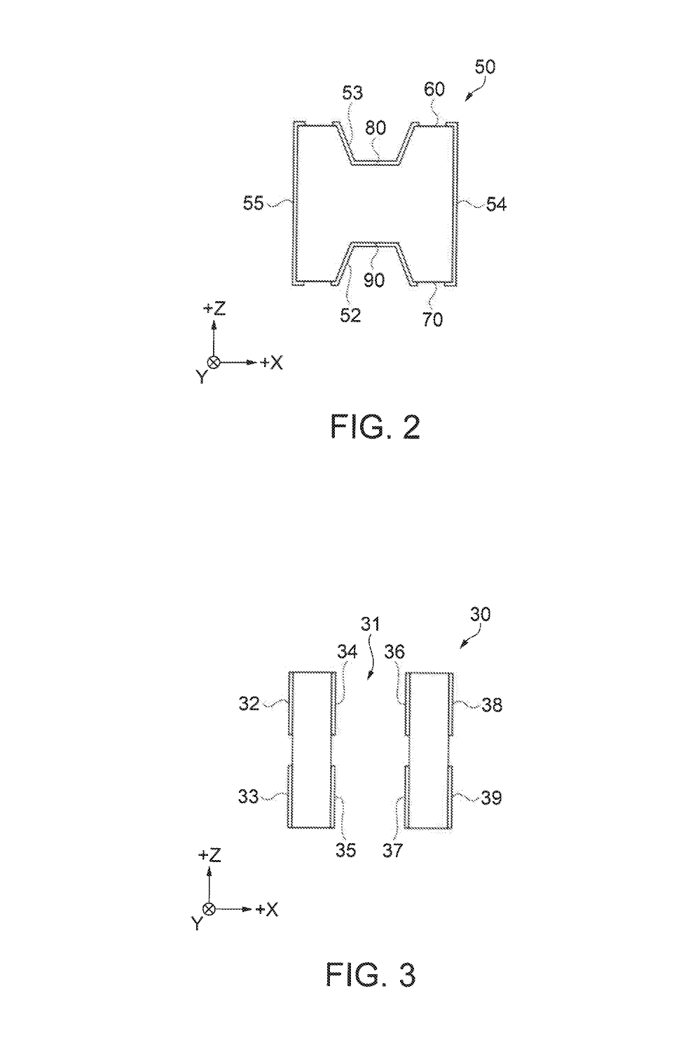

Firstly, a schematic configuration of the sensor element according to the first embodiment will be described using FIG. 1 through FIG. 3 citing a gyro sensor element 1 as an example. FIG. 1 is a plan view schematically showing a general configuration of the sensor element according to the first embodiment. FIG. 2 is a cross-sectional view along the line A-A shown in FIG. 1. Further, FIG. 3 is a cross-sectional view along the line B-B shown in FIG. 1.

As shown in FIG. 1, the gyro sensor element 1 as the sensor element is constituted by a base 10, a pair of driving vibrating arms 40, 50 extending in the −Y-axis direction from one end of the base 10 in a planar view viewed from the +Z-axis side, a pair of detecting vibrating arms 20, 30 extending in the +Y-axis direction from the other end of the base 10 located on the opposite side to the one end of the base 10, from which the driving vibrating arms 40, 50 extend, in the planar view viewed from the +Z-axis side, and so on. In the present embodiment, tip parts of the pair of detecting vibrating arms 20, 30 described above are respectively provided with weight parts (hammer heads) 94, 95 each larger in width (length in the X-axis direction) than the end part on the base 10 side. Similarly, tip parts of the pair of driving vibrating arms 40, 50 described above are respectively provided with weight parts 96, 97. Since such weight parts are provided, miniaturization of the gyro sensor element 1 can be achieved. It should be noted that the detecting vibrating arms 20, 30 and the driving vibrating arms 40, 50 are not required to have the weight parts 94, 95 and the weight parts 96, 97 in the tip parts, and it is also possible for each of the weight parts 94, 95 and the weight parts 96, 97 to be provided with two or more regions different in width from each other.

The cross-sectional shapes of the driving vibrating arm 50 and the detecting vibrating arm 30 in the present embodiment are shown in FIG. 2 and FIG. 3, respectively.

As shown in FIG. 2, the driving vibrating arm 50 is provided with a bottomed groove 80 formed from the first principal surface 60 (a first surface) toward the second principal surface 70 (a second surface), which is located on the opposite side to the first principal surface 60. Further, the driving vibrating arm 50 is provided with a bottomed groove 90 formed from the second principal surface 70 toward the first principal surface 60, which is located on the opposite side to the second principal surface 70. Further, similarly, the driving vibrating arm 40 is provided with a bottomed groove 81 formed from the first principal surface 60 toward the second principal surface 70, which is located on the opposite side to the first principal surface 60. Further, the driving vibrating arm 40 is provided with a bottomed groove 91 formed from the second principal surface 70 toward the first principal surface 60, which is located on the opposite side to the second principal surface 70.

As shown in FIG. 2, on the driving vibrating arm 50, there are disposed driving electrodes 52, 53, 54, and 55 for performing the driving vibration. The driving electrodes 52, 53 are respectively disposed on the inner surfaces of the bottomed grooves 80, 90, and are electrically connected to each other with a wiring electrode (not shown) formed on the base 10 and so on so as to have the same potential. Further, the driving electrodes 54, 55 are respectively disposed on the side surfaces connecting the first principal surface 60 and the second principal surface 70 to each other, and are electrically connected to each other with a wiring electrode (not shown) formed on the base 10 and so on so as to have the same potential. It is possible to make the driving vibrating arm 50 make driving vibration by applying a alternating current voltage having the same frequency as the resonance frequency of the driving vibrating arms 40, 50 between the driving electrodes 52, 53 and the driving electrodes 54, 55. It should be noted that substantially the same driving electrodes as those of the driving vibrating arm 50 are disposed on the driving vibrating arm 40, and the driving electrodes respectively disposed on the inner surfaces of the bottomed grooves located on the first principal surface 60 side and the second principal surface 70 side of the driving vibrating arm 40 are electrically connected to the driving electrodes 54, 55 disposed on the side surfaces of the driving vibrating arm 50 so as to have the same potential. Further, the driving electrodes respectively formed on the side surfaces connecting the first principal surface 60 and the second principal surface 70 of the driving vibrating arm 40 to each other are electrically connected to the driving electrodes 52, 53 disposed on the inner surfaces of the bottomed grooves of the driving vibrating arm 50 so as to have the same potential. It should be noted that it is possible for the driving vibrating arm 50 to be provided with one or more through holes arranged side by side with the bottomed grooves 80, 90 along the Y-axis direction. Further, similarly, it is possible for the driving vibrating arm 40 to be provided with one or more through holes arranged side by side with the bottomed grooves 81, 91 along the Y-axis direction. Further, in the region provided with the through holes of the driving vibrating arm 50, driving electrodes corresponding to the driving electrodes 52, 53, 54, and 55 can be disposed. Further, similarly, in the region provided with the through holes of the driving vibrating arm 40, driving electrodes corresponding to the driving electrodes disposed in the bottomed grooves 81, 91 of the driving vibrating arm can be disposed.

As shown in FIG. 3, the detecting vibrating arm 30 has a through hole 31 penetrating a third principal surface (a third surface) and a fourth principal surface (a fourth surface) in the Z-axis direction. Further, similarly, the detecting vibrating arm 20 has a through hole 21 penetrating the third principal surface (the third surface) and the fourth principal surface (the fourth surface) in the Z-axis direction.

As shown in FIG. 3, on the detecting vibrating arm 30, there are formed detecting electrodes 32, 33, 34, 35, 36, 37, 38, and 39. The detecting electrodes 34, 35 36 and 37 are respectively disposed on inner wall surfaces of the through hole 31, wherein the detecting electrode 34 is disposed on the −X-axis side and the +Z-axis side of the inner wall surfaces of the through hole 31, the detecting electrode 35 is disposed on the −X-axis side and the −Z-axis side of the inner wall surfaces of the through hole 31, the detecting electrode 36 is disposed on the +X-axis side and the +Z-axis side of the inner wall surfaces of the through hole 31, and the detecting electrode 37 is disposed on the +X-axis side and the −Z-axis side of the inner wall surfaces of the through hole 31. The detecting electrodes 32, 33, 38 and 39 are respectively disposed on the side surfaces connecting the third principal surface and the fourth principal surface to each other, wherein the detecting electrode 32 is disposed on the +Z-axis side of the side surface located on the −X-axis side so as to face the detecting electrode 34, and the detecting electrode 33 is disposed on the −Z-axis side of the side surface located on the −X-axis side so as to face the detecting electrode 35. The detecting electrode 38 is disposed on the +Z-axis side of the side surface located on the +X-axis side so as to face the detecting electrode 36, and the detecting electrode 39 is disposed on the −Z-axis side of the side surface located on the +X-axis side so as to face the detecting electrode 37.

The detecting electrodes 32, 35, 36, and 39 are electrically connected to each other with a wiring electrode (not shown) disposed on the base 10 and so on so as to have the same potential. Further, the detecting electrodes 33, 34, 37, and 38 are electrically connected to each other with a wiring electrode (not shown) disposed on the base 10 and so on so as to have the same potential. It should be noted that substantially the same detecting electrodes as those of the detecting vibrating arm 30 are also disposed on the detecting vibrating arm 20, and the detecting electrodes of the detecting vibrating arm 20 corresponding respectively to the positions of the detecting electrodes 32, 35, 36, and 39 in the detecting vibrating arm 30 are electrically connected to the detecting electrodes 33, 34, 37, and 38 of the detecting vibrating arm 30. The detecting electrodes of the detecting vibrating arm 20 corresponding to the positions of the detecting electrodes 33, 34, 37, and 38 in the detecting vibrating arm 30 are electrically connected to the detecting electrodes 32, 35, 36, and 39 of the detecting vibrating arm 30.

The driving electrodes 52, 53, 54, and 55 and the detecting electrodes 32, 33, 34, 35, 36, 37, 38, and 39 described above can be formed using, for example, a process called photolithography including photoresist application, exposure, development, etching, photoresist removal, and so on. In the exposure in the photolithography process, if the surface, which should not essentially be exposed, is irradiated with the light having diffusely been reflected, there is a possibility that the electrodes cannot be formed to have desired shapes.

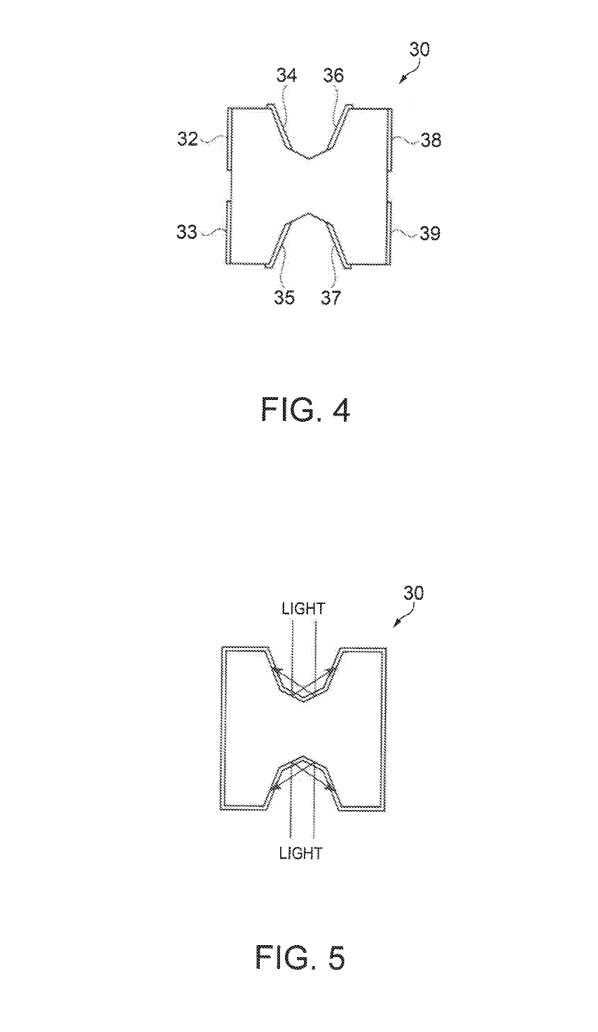

For example, as shown in FIG. 4, in the case in which bottomed grooves are provided to the detecting vibrating arms 20, 30 instead of the through holes 21, 31 of the present embodiment, the detecting electrodes 34, 35, 36, and 37 are disposed on the inner side surfaces of the bottomed grooves. In the case of forming the bottomed grooves using, for example, wet etching, due to the influence of the anisotropy in the crystal of the substrate, there are formed shapes having crystal surfaces nonparallel to the obverse and reverse surfaces of the substrate in the bottom parts of the bottomed grooves.

In the case of forming the detecting electrodes in the bottomed grooves using the photolithography process, an electrode film is formed on the inner surface of each of the bottomed grooves and the photoresist is applied, and then, pattern exposure is performed on the bottom part of each of the bottomed grooves in order to separate the electrode formed on the −X-side side surface and the electrode formed on the +X-side side surface from each other in each of the bottomed grooves. On this occasion, as shown in FIG. 5, there is a possibility that the side surface part of each of the bottomed grooves, which should not essentially be exposed, is also exposed due to the diffuse reflection of the exposure light by the crystal surfaces of the bottom part of each of the bottomed grooves, and thus, there is a possibility that the photoresist pattern fails to become the desired shape. If etching the electrode film using the photoresist pattern, which has failed to have the desired shape, the detecting electrodes 34, 35, 36, and 37 fail to have the desired shapes, for example, the detecting electrodes 34, 35, 36, and 37 cannot be formed, or the detecting electrodes 34, 35, 36, and 37 are electrically connected to other electrodes. Therefore, there is a possibility that the performance of the gyro sensor element 1 degrades.

Since the gyro sensor element 1 according to the present embodiment has the through holes 21, 31 respectively in the detecting vibrating arms 20, 30, no bottom part is provided inside the through holes 21, 31. Therefore, there is reduced the possibility that the light is diffusely reflected when performing the exposure in the photolithography process described above. Further, in the present embodiment, since it is sufficient for the exposure light in the photolithography process to be emitted obliquely to the vicinity of the center of the inner wall surface of each of the through holes 21, 31, for example, the possibility that the light is diffusely reflected is reduced, and thus, it is easy to form the photoresist pattern to have the desired shape. Therefore, since the detecting electrodes 34, 35, 36, and 37 fail to be formed, or are electrically connected to other electrodes, there is reduced the possibility that the performance of the gyro sensor element 1 degrades. Further, since the through holes 21, 31 are provided, it is possible to decrease the length between the inner wall surfaces of the through holes 21, 31 of the detecting vibrating arms 20, 30 and the side surfaces of the detecting vibrating arms 20, 30, namely the thickness of the wall between the inner wall surfaces of the through holes 21, 31 of the detecting vibrating arms 20, 30 and the side surfaces of the detecting vibrating arms 20, 30. Therefore, it is also possible to increase the electrical field efficiency to obtain the gyro sensor element 1 high in sensitivity. It should be noted that it is possible for the detecting vibrating arm 30 to be provided with one or more bottomed grooves, which are not provided with the detecting electrodes 32, 33, 34, 35, 36, 37, 38, and 39, and are arranged side by side with the through hole 31 along the Y-axis direction. Further, similarly, it is possible for the detecting vibrating arm 20 to be provided with one or more bottomed grooves, which are not provided with detecting electrodes corresponding to the detecting electrodes 32, 33, 34, 35, 36, 37, 38, and 39 in the detecting vibrating arm 30, and are arranged side by side with the through hole 21 along the Y-axis direction.

Then, the driving vibrating state of the gyro sensor element 1 according to the present embodiment will be described using FIG. 6. The driving vibrating arms 40, 50 as the arm parts make a flexural vibration in the opposite direction along the X-axis direction among the in-plane directions in the plane defined by the X axis and the Y axis. Specifically, when the driving vibrating arm 40 is displaced toward the −X direction, the driving vibrating arm 50 is displaced toward the +X direction, and when the driving vibrating arm 40 is displaced toward the +X direction, the driving vibrating arm 50 is displaced toward the −X direction. In such a vibrator making the flexural vibration in the in-plane direction, since there are provided the bottomed grooves 80, 81, 90, and 91, there can be obtained an advantage of increasing the electrical field efficiency to increase the equivalent series capacitance (C1) in the equivalent circuit constants. Further, at the same time, there can be obtained an advantage of decreasing the thermoelastic loss due to the heat generated by the vibration moving in the same direction as the vibration direction via the bottomed grooves 80, 81, 90, and 91 to thereby improve the Q-value. Therefore, the drive impedance can be decreased, and thus, the gyro sensor element 1 low in current consumption can be obtained.

The operation principle of the gyro sensor element 1 according to the present embodiment will be described using FIG. 6 and FIG. 7.

In the drive mode shown in FIG. 6, when a predetermined alternating-current voltage is applied to the driving electrodes, the driving vibrating arms 40, 50 make the flexural vibrations (in-plane mode vibrations) in directions opposite to each other, namely in directions of getting closer to and away from each other, in the in-plane directions of the X-Y plane as shown in FIG. 6.

When an angular velocity ω rotating around the Y axis, which is the extending direction of each of the vibrating arms, is applied to the gyro sensor element 1 in this state, the driving vibrating arms 40, 50 make the flexural vibrations (out-of-plane mode vibrations) in directions opposite to each other along the out-of-plane direction perpendicular to the principal surface, namely the Z-axis direction, as shown in FIG. 7 due to the action of the Coriolis force generated in accordance with the angular velocity ω. The detecting vibrating arms 20, 30 make the flexural vibrations (the out-of-plane mode vibrations) in the directions opposite to each other along the Z-axis direction in resonance with the vibrations in the Z-axis direction. On this occasion, the vibration directions of the detecting vibrating arms 20, 30 are in reverse phase with the vibration directions of the driving vibrating arms 40, 50. Specifically, the vibration direction in the out-of-plane vibration mode of the driving vibrating arm 40 is in reverse phase with the vibration direction in the out-of-plane vibration mode of the detecting vibrating arm 20, and the vibration direction in the out-of-plane vibration mode of the driving vibrating arm 50 is in reverse phase with the vibration direction in the out-of-plane vibration mode of the detecting vibrating arm 30.

When the driving vibrating arm 40 is displaced toward the +Z-axis direction, the driving vibrating arm 50 makes the flexural vibration of the out-of-plane mode vibration displaced toward the −Z-axis direction. The flexural vibrations in the out-of-plane mode of the driving vibrating arms 40, 50 are propagated to the detecting vibrating arms 20, 30 via the base 10 to resonate the detecting vibrating arms 20, 30, and when the detecting vibrating arm 20 is displaced toward the −Z-axis direction, the detecting vibrating arm 30 makes the flexural vibration in the out-of-plane mode displaced toward the +Z-axis direction.

The angular velocity ω applied to the gyro sensor element 1 is obtained based on the amount of charge generated between the detecting electrodes of the detecting vibrating arms 20, 30 due to the flexural vibration in the Z-axis direction of the detecting vibrating arms 20, 30.

The constituent material of such a gyro sensor element 1 is not particularly limited providing the material can exert desired vibration characteristics, and a variety of piezoelectric materials and a variety of non-piezoelectric materials can be used.

For example, as the piezoelectric materials constituting the gyro sensor element 1, a quartz crystal, a lithium tantalate, a lithium niobate, a lithium tetraborate, a zinc oxide, an aluminum nitride, a barium titanate and so on can be cited. In particular, as the piezoelectric material constituting the gyro sensor element 1, a quartz crystal (e.g., an X-cut quartz crystal, an AT-cut quartz crystal, and a Z-cut quartz crystal) is preferable. If the gyro sensor element 1 is formed of the quartz crystal, it is possible to make the vibration characteristics (in particular the frequency-temperature characteristic) of the gyro sensor element 1 excellent.

Further, as the non-piezoelectric material constituting the gyro sensor element 1, there can be cited, for example, silicon and quartz. In particular, silicon is preferable as the non-piezoelectric material constituting the gyro sensor element 1. By constituting the gyro sensor element 1 with silicon, the gyro sensor element 1 with excellent vibration characteristics can be realized at relatively low cost. Further, it is possible to form the gyro sensor element 1 by etching with high dimensional accuracy using a known microfabrication technology. It should be noted that in the case of using the non-piezoelectric body as the material constituting the gyro sensor element 1, as the drive unit of the gyro sensor element 1, it is possible to use electrostatic drive using Coulomb force, or the piezoelectric effect by disposing the piezoelectric material described above and the electrodes for exciting the piezoelectric material on the gyro sensor element 1. Further, the sensor element can be an element for detecting a physical quantity such as an element for an inertia sensor (e.g., an acceleration sensor), or a force sensor (e.g., a tilt sensor) besides the gyro sensor element 1 according to the present embodiment.

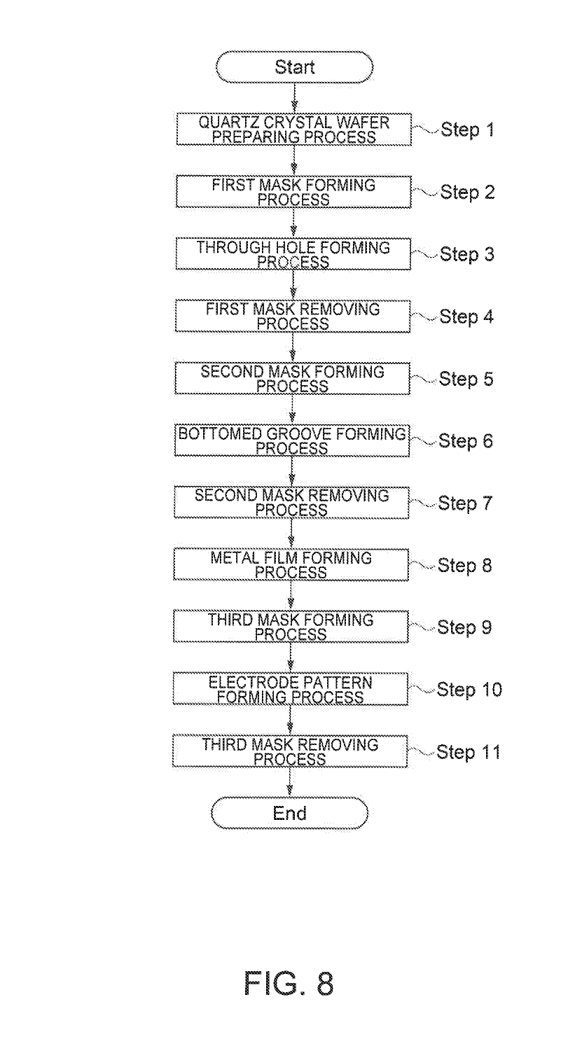

Then, an example of a method of manufacturing the gyro sensor element 1 according to the present embodiment will be shown in the flowchart of FIG. 8.

As shown in FIG. 8, the method of manufacturing the gyro sensor element 1 includes a quartz crystal wafer preparing process (Step 1) for preparing a quartz crystal wafer having an obverse surface and a reverse surface, a first mask forming process (Step 2) for forming a first mask for forming an outer shape of the gyro sensor element 1 and the through holes on the quartz crystal wafer, a through hole forming process (Step 3) for forming the outer shape and the through holes by etching the quartz crystal wafer via the first mask, a first mask removing process (Step 4) for removing the first mask, a second mask forming process (Step 5) for forming a second mask for forming the bottomed grooves on the quartz crystal wafer, a bottomed groove forming process (Step 6) for forming the bottomed grooves by etching the quartz crystal wafer via the second mask, a second mask removing process (Step 7) for removing the second mask, a metal film forming process (Step 8) for forming a metal film on the quartz crystal wafer, a third mask forming process (Step 9) for forming a third mask for etching the metal film, an electrode pattern forming process (Step 10) for forming an electrode pattern by etching the metal film via the third mask, and a third mask removing process (Step 11) for removing the third mask.

Due to this method, it is possible to form the outer shape part of the gyro sensor element 1, to provide the bottomed grooves 80, 81, 90, and 91 to the driving vibrating arms 40, 50, and to provide the through holes 21, 31 to the detecting vibrating arms 20, 30, respectively.

It should be noted that the bottomed grooves 80, 81, 90, and 91 can be formed using wet etching using a liquid such as mixed acid, dry etching using a variety of types of halogenated gas such as a fluorine atom-containing compound gas such as CF₄, C₂F₆, C₃F₆, C₄Fe, CClF₃, or SF₆, or a chlorine atom-containing compound gas such as Cl₂, BCl₃, or CCl₄, and so on. If the bottomed grooves 80, 81, 90, and 91 are formed using wet etching, etching from the obverse side and etching from the reverse side can be performed at the same time. Therefore, it becomes possible to simplify the manufacturing process, and thus, reduction of the manufacturing cost can be achieved. Further, if the bottomed grooves 80, 81, 90, and 91 are formed using dry etching, the possibility that the shape after etching differs from the desired shape due to the influence of the crystal structure or the like of the member to be etched can be reduced compared to the case of using wet etching, and therefore, it is possible to obtain the gyro sensor element 1 having the vibration characteristics small in difference from the desired vibration characteristics.

Further, the outer shape and the through holes can be formed using wet etching using a liquid such as mixed acid, dry etching using a variety of types of halogenated gas such as a fluorine atom-containing compound gas such as CF₄, C₂F₆, C₃F₆, C₄F₈, CClF₃, or SF₆, or a chlorine atom-containing compound gas such as Cl₂, BCl₃, or CCl₄, and so on, and dry etching is preferably used. In the wet etching, there is a possibility that the shape after the etching differs from the desired shape due to the influence of the crystal structure or the like of the member to be etched. Since the dry etching is hard to be affected by the crystal structure or the like of the member to be etched, it is possible to reduce the possibility that the shape after the etching differs from the desired shape, and it is possible to obtain the gyro sensor element 1 having the vibration characteristics small in difference from the desired vibration characteristics.

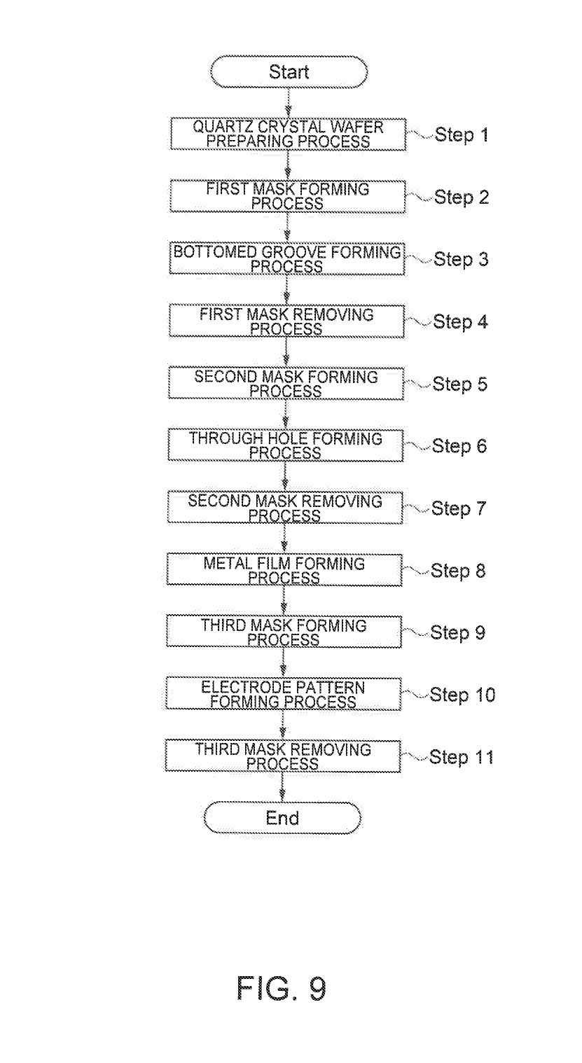

Then, another example of the method of manufacturing the gyro sensor element 1 according to the present embodiment will be shown in the flowchart of FIG. 9.

As shown in FIG. 9, the method of manufacturing the gyro sensor element 1 includes a quartz crystal wafer preparing process (Step 1) for preparing a quartz crystal wafer having an obverse surface and a reverse surface, a first mask forming process (Step 2) for forming a first mask for first dry etching for forming bottomed grooves on the quartz crystal wafer, a bottomed groove forming process (Step 3) for forming the bottomed grooves by the first dry etching, a first mask removing process (Step 4) for removing the first mask for the first dry etching, a second mask forming process (Step 5) for forming a second mask for second dry etching for forming an outer shape of the gyro sensor element 1 and the through holes, a through hole forming process (Step 6) for forming the outer shape and the through holes by the second dry etching, a second mask removing process (Step 7) for removing the second mask for the second dry etching, a metal film forming process (Step 8) for forming a metal film on the quartz crystal wafer, a third mask forming process (Step 9) for forming a third mask for etching the metal film, an electrode pattern forming process (Step 10) for forming an electrode pattern by etching the metal film via the third mask, and a third mask removing process (Step 11) for removing the third mask.

In the method described above, the outer shape part of the gyro sensor element 1, the bottomed grooves 80, 81, 90, and 91 provided to the driving vibrating arms 40, 50, and the through holes 21, 31 provided to the detecting vibrating arms 20, 30 are formed using dry etching. The dry etching using a variety of types of halogenated gas such as a fluorine atom-containing compound gas such as CF₄, C₂F₆, C₃F₆, C₄F₈, CClF₃, or SF₆, or a chlorine atom-containing compound gas such as Cl₂, BCl₃, or CCl₄, and so on is hard to be affected by the crystal structure or the like of the member to be etched compared to the wet etching using a liquid such as mixed acid. Therefore, it is possible to reduce the possibility that the shape after the etching differs from the desired shape, and it is possible to obtain the gyro sensor element 1 having the vibration characteristics small in difference from the desired vibration characteristics. Further, since the bottomed grooves 80, 81, 90, and 91 are formed using the first dry etching, the influence of the crystalline anisotropy can be reduced. Therefore, it is possible to reduce the variation in the thickness between the inner surface of the groove and the side surface of the driving vibrating arm in the Y-axis direction, namely the thickness of the wall part, and it is also possible to improve the electrical field efficiency of the driving vibrating arms 40, 50 to thereby make the equivalent series capacitance (C1) in the equivalent circuit constants higher.

As described hereinabove, it is possible for the gyro sensor element 1 according to the first embodiment to increase the electrical field efficiency in the driving vibrating arms 40, 50, and to suppress the thermoelastic loss to a low level, and thus, it is possible to obtain the gyro sensor element 1 low in impedance and low in current consumption. Further, in the detecting vibrating arms 20, 30, since the through holes 21, 31 are provided, and thus, the diffuse reflection when performing the exposure in the process of forming the electrodes can be reduced, it becomes easy to form the electrodes having the desired shapes on the inner wall surfaces of the through holes 21, 31, and thus, the possibility that the performance of the gyro sensor element 1 deteriorates can be decreased. Further, by forming the electrodes on the wall parts, it is also possible to enhance the electrical field effect to thereby easily obtain the gyro sensor element 1 high in sensitivity.

### Second Embodiment

Then, a gyro sensor element 2 as a sensor element according to the second embodiment of the invention will be described using FIG. 10. FIG. 10 is a plan view schematically showing a general configuration of the gyro sensor element 2 according to the second embodiment. Hereinafter, the second embodiment will be described. The following explanation is focused mainly on the differences from the first embodiment, and the explanation of substantially the same matters will be omitted. The gyro sensor element 2 according to the second embodiment is substantially the same as the gyro sensor element 1 according to the first embodiment except the fact that the configuration of the through holes provided to the pair of detecting vibrating arms 220, 230 is different.

As shown in FIG. 10, the detecting vibrating arm 220 of the gyro sensor element 2 has two through holes 221, 222 along the Y-axis direction in which the detecting vibrating arm 220 extends. Similarly, the detecting vibrating arm 230 has two through holes 231, 232 along the Y-axis direction in which the detecting vibrating arm 230 extends. By disposing the through holes 221, 222, 231, and 232 as described above, the longest diameter in each of the through holes 221, 222, 231, and 232 becomes smaller than the longest diameter in each of the through holes 21, 31 of the first embodiment in the planar view viewed from the +Z-axis side. In general, in the structure having the through holes, the smaller the longest diameter in the through holes is (in other words, the smaller the area in the planar view is), the smaller the distortion generated in the case in which the stress is applied to the structure becomes. Therefore, the distortion caused in the detecting vibrating arms 220, 230 when the stress such as an impact is applied to the gyro sensor element 2 can be made smaller compared to the case in which substantially the same stress such as an impact is applied to the gyro sensor element 1 according to the first embodiment. Therefore, it is possible for the gyro sensor element 2 according to the second embodiment to have substantially the same advantages as those of the gyro sensor element 1 according to the first embodiment, and at the same time, obtain an advantage of improving the impact resistance compared to the gyro sensor element 1 according to the first embodiment. It should be noted that the through holes 221, 222, 231, and 232 provided to the detecting vibrating arms 220, 230 are not limited to the two through holes provided to each of the detecting vibrating arms 20, 30, but it is also possible to form three or more through holes along the Y-axis direction.

### Third Embodiment

Then, a gyro sensor element 3 as a sensor element according to the third embodiment of the invention will be described using FIG. 11. FIG. 11 is a plan view schematically showing a general configuration of the gyro sensor element 3 according to the third embodiment. Hereinafter, the third embodiment will be described. The following explanation is focused mainly on the differences from the first embodiment, and the explanation of substantially the same matters will be omitted.

As shown in FIG. 11, the gyro sensor element 3 is constituted by a base 310, a pair of driving vibrating arms 320, 330 extending from one end of the base 310 toward the +Y-axis direction in the planar view viewed from the +Z-axis side, a detecting vibrating arm 340 extending toward the +Y-axis direction from the one end of the base 310 from which the driving vibrating arms 320, 330 extend, and so on. Specifically, in the planar view viewed from the +Z-axis side, the driving vibrating arms 320, 330 are arranged side by side in the X-axis direction, and the detecting vibrating arm 340 is arranged side by side with the driving vibrating arms 320, 330 on the +X-axis side in the X-axis direction. The driving vibrating arms 320, 330 each have bottomed grooves and driving electrodes similarly to the driving vibrating arms 40, 50 of the first embodiment, and the detecting vibrating arm 340 has a through hole and detecting electrodes similarly to the detecting vibrating arms 20, 30 according to the first embodiment. Also in the gyro sensor element 3 according to the present embodiment, substantially the same advantage as that of the gyro sensor element 1 according to the first embodiment can be obtained. It should be noted that although in the present embodiment, the detecting vibrating arm 340 is arranged side by side with the pair of driving vibrating arms 320, 330 on the +X-axis side, this is not a limitation, and it is also possible for the detecting vibrating arm 340 to be arranged side by side with the driving vibrating arms 320, 330 on the −X-axis side in the X-axis direction in the planar view viewed from the +Z-axis side. Further, the number of detecting vibrating arms is not limited to one, but it is also possible to have two or more detecting vibrating arms. Further, in the case of having two or more detecting vibrating arms, the two or more detecting vibrating arms can be disposed on both sides of the pair of driving vibrating arms 320, 330, or can also be arranged side by side with the pair of driving vibrating arms 320, 330 on the +X-axis side or the −X-axis side in the X-axis direction in the planar view viewed from the +Z-axis side. Further, the number of driving vibrating arms can also be larger than one pair (two), namely three or more driving vibrating arms can also be provided. It should be noted that it is also possible for the detecting vibrating arm 340 to be provided with two or more through holes along the Y-axis direction in which the detecting vibrating arm 340 extends similarly to the detecting vibrating arms 220, 230 of the gyro sensor element 2 according to the second embodiment.

In the present embodiment, when a predetermined alternating-current voltage is applied to the driving electrodes provided to the driving vibrating arms 320, 330, the driving vibrating arms 320, 330 make the flexural vibrations (the in-plane mode vibrations) in directions opposite to each other, namely in directions of getting closer to and away from each other, in the in-plane directions in the X-Y plane. When an angular velocity ω rotating around the Y axis, which is the extending direction of each of the vibrating arms, is applied to the gyro sensor element 3 in this state, the driving vibrating arms 320, 330 make the flexural vibrations (out-of-plane mode vibrations) in directions opposite to each other along the out-of-plane direction perpendicular to the principal surface, namely the Z-axis direction, due to the action of the Coriolis force generated in accordance with the angular velocity ω. The detecting vibrating arm 340 makes the flexural vibration (the out-of-plane mode vibration) in the Z-axis direction in resonance with the vibration in the Z-axis direction. The angular velocity ω applied to the gyro sensor element 3 is obtained based on the amount of charge generated between the detecting electrodes of the detecting vibrating arm 340 due to the flexural vibration in the Z-axis direction of the detecting vibrating arm 340.

### Fourth Embodiment

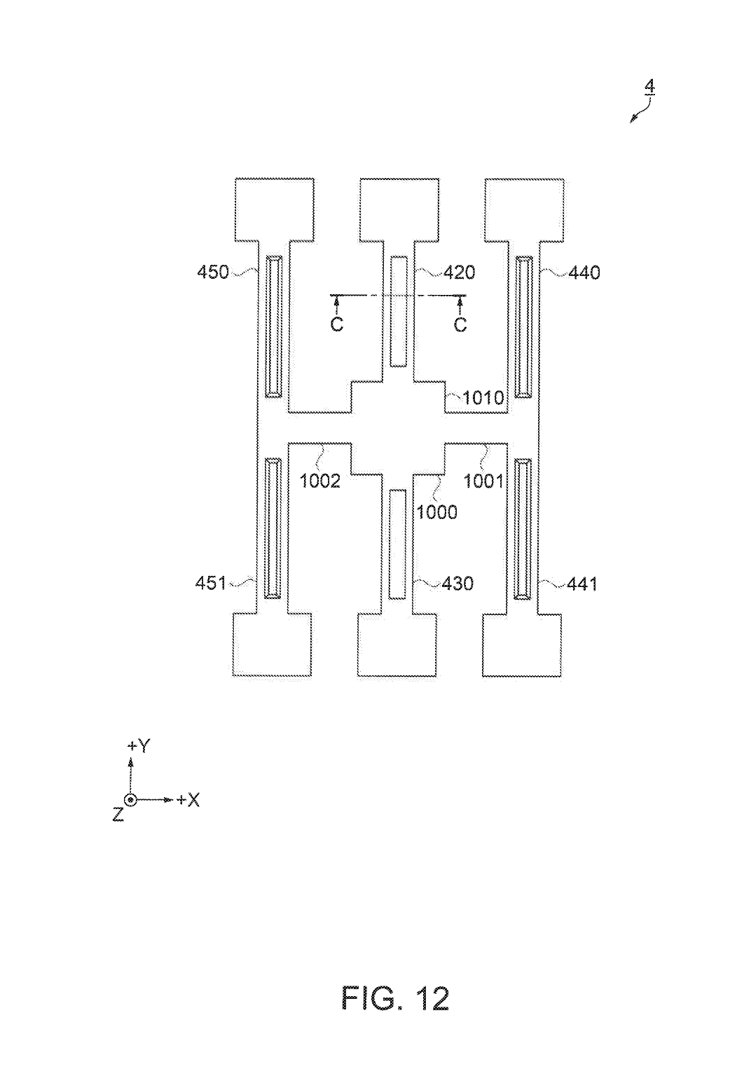

Then, a gyro sensor element 4 as a sensor element according to the fourth embodiment of the invention will be described using FIG. 12. FIG. 12 is a plan view schematically showing a general configuration of the gyro sensor element 4 according to the fourth embodiment. Hereinafter, the fourth embodiment will be described. The following explanation is focused mainly on the differences from the first embodiment, and the explanation of substantially the same matters will be omitted. It should be noted that in the case of defining the two directions perpendicular to each other as a first direction and a second direction, the explanation will be presented defining the first direction as the Y-axis direction, and the second direction as the X-axis direction.

As shown in FIG. 12, the gyro sensor element 4 is constituted by a base 1010 having a support part 1000 and a first connecting part 1001 and a second connecting part 1002 extending along the X-axis direction from the both sides of the support part 1000, a first detecting vibrating arm 420 extending in the +Y-axis direction from an end part on the +Y-axis side of the support part 1000, a second detecting vibrating arm 430 extending in the −Y-axis direction from an end part on the −Y-axis side of the support part 1000, a first driving vibrating arm 440 extending in the +Y-axis direction from an end part on the +Y-axis side of the first connecting part 1001, a second driving vibrating arm 441 extending in the −Y-axis direction from an end part on the −Y-axis side of the first connecting part 1001, a third driving vibrating arm 450 extending in the +Y-axis direction from an end part on the +Y-axis side of the second connecting part 1002, and a fourth driving vibrating arm 451 extending in the −Y-axis direction from an end part on the −Y-axis side of the second connecting part 1002, and so on. The first through fourth driving vibrating arms 440, 441, 450, and 451 are each provided with bottomed grooves and driving electrodes similarly to the first embodiment. Further, the first and second detecting vibrating arms 420, 430 are each provided with a through hole and detecting electrodes similarly to the first embodiment.

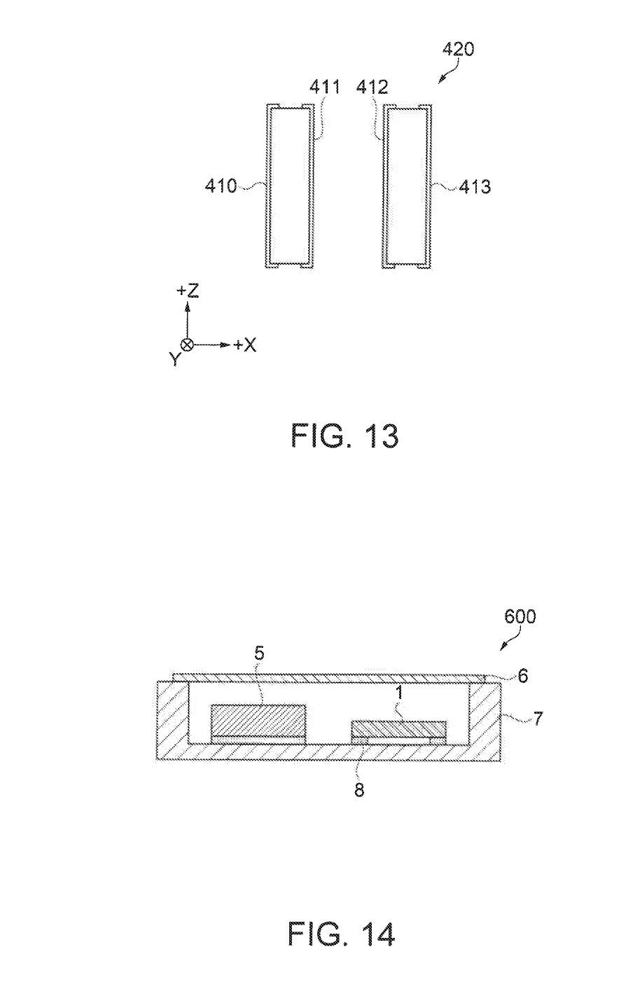

Then, electrodes disposed on the first detecting vibrating arm 420 will be described using FIG. 13.

FIG. 13 is a C-C cross-sectional view in FIG. 12. As shown in FIG. 13, the first detecting vibrating arm 420 is provided with detecting electrodes 410, 411, 412, and 413, and the detecting electrodes 411, 412 are electrically connected to each other with a wiring electrode (not shown) disposed on the base 1010 and so on so as to have the same potential. Further, the detecting electrodes 410, 413 are electrically connected to each other with a wiring electrode (not shown) disposed on the base 1010 and so on so as to have the same potential. It should be noted that the second detecting vibrating arm 430 is also provided with substantially the same detecting electrodes as those of the first detecting vibrating arm 420. The detecting electrodes disposed on the inner wall surfaces of the through hole of the second detecting vibrating arm 430 are electrically connected to the detecting electrodes 410, 413 disposed on the side surfaces connecting the surface on the +Z-axis side and the surface on the −Z-axis side of the first detecting vibrating arm 420 so as to have the same potential. The detecting electrodes disposed on the side surfaces connecting the surface on the +Z-axis side and the surface on the −Z-axis side to each other of the second detecting vibrating arm 430 are electrically connected to the detecting electrodes 411, 412 disposed on the inner wall surfaces of the through hole of the first detecting vibrating arm 420 so as to have the same potential. Also in the gyro sensor element 4 according to the present embodiment, substantially the same advantage as that of the gyro sensor element 1 according to the first embodiment can be obtained.

In the present embodiment, when a predetermined alternating-current voltage is applied to the driving electrodes provided to the first through fourth driving vibrating arms 440, 441, 450, and 451, the first and second driving vibrating arms 440, 441 and the third and fourth driving vibrating arms 450, 451 make the flexural vibrations (the in-plane mode vibrations) in directions opposite to each other, namely in directions of getting closer to and away from each other, in the in-plane directions in the X-Y plane. Specifically, when the first and second driving vibrating arms 440, 441 are displaced toward the −X-axis direction, the third and fourth driving vibrating arms 450, 451 are displaced toward the +X-axis direction, and when the first and second driving vibrating arms 440, 441 are displaced toward the +X-axis direction, the third and fourth driving vibrating arms 450, 451 are displaced toward the −X-axis direction.

When an angular velocity ω rotating around the Z axis, which is perpendicular to the principal surface, is applied to the gyro sensor element 4 in this state, the first through fourth driving vibrating arms 440, 441, 450, and 451 vibrate in the Y-axis direction, which is the extending direction of each of the vibrating arms, due to the action of the Coriolis force generated in accordance with the angular velocity (o. In resonance with the vibration in the Y-axis direction, the first and second detecting vibrating arms 420, 430 make a flexural vibration in the X-axis direction. The angular velocity C applied to the gyro sensor element 4 is obtained based on the amount of charge generated between the detecting electrodes of the first and second detecting vibrating arms 420, 430 due to the flexural vibration in the X-axis direction of the first and second detecting vibrating arms 420, 430. It should be noted that it is also possible for the first and second detecting vibrating arms 420, 430 to be provided with two or more through holes along the Y-axis direction, in which the first and second detecting vibrating arms 420, 430 extends, similarly to the detecting vibrating arms 220, 230 of the gyro sensor element 2 according to the second embodiment.

### Gyro Sensor

Then, the gyro sensor will be cited as an example of the sensor equipped with the sensor element according to any one of the embodiments described above, and will be described using FIG. 14.

FIG. 14 is a cross-sectional view of a gyro sensor 600 equipped with the sensor element according to any one of the embodiments described above. It should be noted that in the present embodiment, the explanation will be presented illustrating the gyro sensor having the gyro sensor element 1 as the sensor element.

As shown in FIG. 14, in the gyro sensor 600, the gyro sensor element 1, and an electronic component 5 including a circuit for driving the gyro sensor element 1, and a circuit for detecting signals are housed in a recessed part of a package 7, and an opening part of the package 7 is closed with a cap 6 to thereby keep the inside airtight.

The package 7 is formed of a material having an insulating property. Such a material is not particularly limited, and there can be used a variety of types of ceramics such as oxide ceramics, nitride ceramics, or carbide ceramics, resin, glass, or the like. The cap 6 can be formed of a metal material such as a Kovar alloy, or can also be formed of ceramic, resin, glass or the like.

The gyro sensor element 1 housed in the package 7 is mechanically and electrically connected to the package 7 with a bonding member 8. By using an electrically-conductive bonding member such as an electrically-conductive adhesive, or a metal bump as the bonding member 8, mechanical connection can be achieved while achieving electrical connection. It should be noted that it is also possible for the gyro sensor element 1 to be mechanically connected to the package 7 with the bonding member 8, and electrically connected to the package 7 with bonding wires or the like. Further, similarly, it is also possible for the electronic component 5 to be mechanically and electrically connected to the package 7 using an electrically-conductive bonding member such as an electrically-conductive adhesive or a metal bump, or to be mechanically connected to the package 7 with the bonding member, and electrically connected to the package 7 with the bonding wires or the like. Further, the gyro sensor element 1 and the electronic component 5 are electrically connected to each other with interconnections not shown disposed on the surfaces of the recessed part and the inside of the package 7. Further, at least one of the gyro sensor element 1 and the electronic component 5 is electrically connected to external connection terminals not shown disposed on the outer surface of the package 7 via interconnections not shown disposed on the surfaces of the recessed part and the inside of the package 7. The gyro sensor 600 outputs the signal, which corresponds to the angular velocity ω applied, via the external connection terminals described above.

According to the gyro sensor 600 described above, since the gyro sensor element 1 is housed in the package 7, it becomes hard to be affected by a disturbance, and it becomes possible to stabilize the detection characteristics of the angular velocity and so on.

### Electronic Apparatus

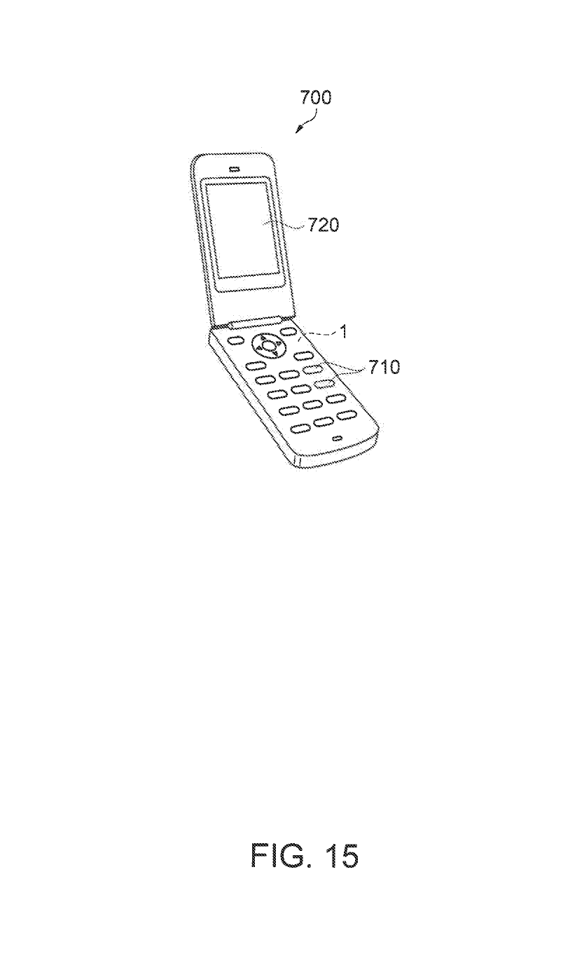

Then, an electronic apparatus equipped with the sensor element according to any one of the embodiments described above will be described using FIG. 15.

FIG. 15 is a perspective view showing a cellular phone as an electronic apparatus equipped with the sensor element according to any one of the embodiments described above. It should be noted that in the present embodiment, the explanation will be presented illustrating the cellular phone having the gyro sensor element 1.

A cellular phone 700 is provided with a plurality of operation buttons 710, and a display unit 720. By holding down the operation buttons 710, it is possible to operate the screen displayed on the display unit 720. By implementing the gyro sensor element 1 according to the embodiment described above to such a cellular phone 700, a variety of functions can be provided to the cellular phone 700. For example, it is possible to provide a camera (not shown) installed in the cellular phone 700 shown in FIG. 15 with an image stabilization function.

It should be noted that the electronic apparatus equipped with the sensor element according to the invention can be applied to, for example, a smartphone, a tablet terminal, a timepiece (including a smart watch), a personal computer (e.g., a mobile type personal computer), an inkjet ejection device (e.g., an inkjet printer), a laptop personal computer, a storage area network apparatus such as a router or a switch, a local area network apparatus, a mobile terminal base station apparatus, a real-time clock device, a television set, a digital camera, a video camera, a video cassette recorder, a car navigation system, a pager, a personal digital assistance (including one having a communication function), an electronic dictionary, an electronic calculator, an electronic game machine, a word processor, a workstation, a picture phone, a security television monitor, an electronic binoculars, a POS terminal, a medical instrument (e.g., an electronic thermometer, a blood pressure monitor, a blood glucose monitor, an electrocardiograph, ultrasonic diagnostic equipment, and an electronic endoscope), a fish finder, a variety of measuring instruments such as a gas meter, a water meter, an electricity meter (a smart meter) each provided with a wired or wireless communication function, and capable of transmitting a variety of data, a variety of measurement apparatuses, gauges (e.g., gauges for cars, aircrafts, and boats and ships), a flight simulator, a wearable terminal such as a head-mounted display, a motion tracer, a motion tracker, a motion controller, and a pedestrian dead reckoning (PDR) system besides the cellular phone 700 shown in FIG. 15.

### Moving Object

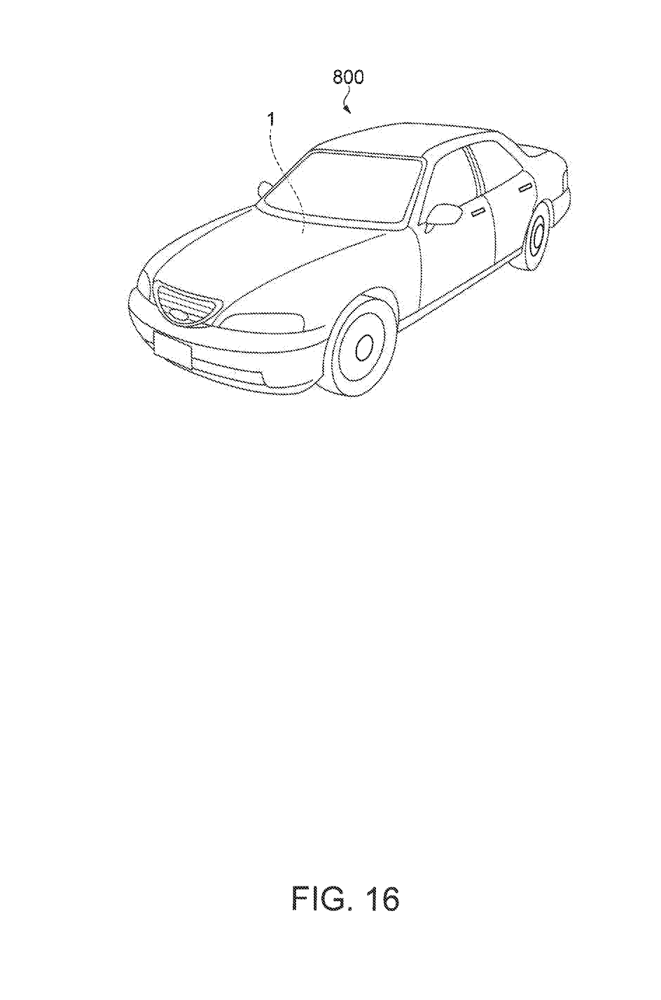

Then, a moving object equipped with the gyro sensor element according to any one of the embodiments described above will be described using FIG. 16.

FIG. 16 is a perspective view showing a car as a moving object equipped with the gyro sensor element according to any one of the embodiments described above. It should be noted that in the present embodiment, the explanation will be presented illustrating the car having the gyro sensor element 1.

The car 800 is equipped with a car navigation system incorporating the gyro sensor element 1. Further, besides the above, the gyro sensor element 1 can widely be applied to an electronic control unit (ECU) such as a keyless entry system, an electronic control unit for controlling tires and so on, a vehicle attitude control system, an immobilizer, a car air-conditioner, an anti-lock braking system (ABS), an air-bag system, a tire pressure monitoring system (TPMS), an engine controller, a battery monitor for a hybrid car or an electric car.

It should be noted that the moving object equipped with the sensor element according to the invention is not limited to a car, but can also be applied to, for example, a wheeled vehicle such as a bicycle, a motorbike, or a train, an airplane, a helicopter, a ship, a boat, a spaceship, a two-legged robot, a radio-controlled helicopter, a radio-controlled car, and a drone.

The entire disclosure of Japanese Patent Application No. 2016-027688, filed Feb. 17, 2016 is expressly incorporated by reference herein.

What is claimed is:

1. A sensor element comprising:
a base;
a driving vibrating arm, which extends from the base, has a first surface and a second surface located on an opposite side to the first surface, and makes a driving vibration; and
a detecting vibrating arm, which extends from the base, has a third surface located on a same side as the first surface and a fourth surface located on an opposite side to the third surface, and vibrates in accordance with a physical quantity applied to the driving vibrating arm,
wherein the driving vibrating arm has a bottomed groove on at least one of the first surface and the second surface, and a driving electrode disposed on an inner surface of the bottomed groove, and
the detecting vibrating arm has a through hole penetrating the detecting vibrating arm in a direction crossing the third surface and the fourth surface, and a detecting electrode disposed at least a part of an inner wall surface of the through hole.

2. The sensor element according to claim 1, wherein
the two or more through holes are disposed along a direction in which the detecting vibrating arm extends.

3. The sensor element according to claim 1, wherein
the two or more driving vibrating arms extend from one end of the base, and are arranged side by side in a planar view, and
the two or more detecting vibrating arms extend from the other end located on an opposite side to the one end of the base, and are arranged side by side in the planar view.

4. The sensor element according to claim 1, wherein
the two or more driving vibrating arms extend from one end of the base, and are arranged side by side in a planar view, and
the at least one detecting vibrating arm extends from the one end of the base, and is arranged side by side with the two or more driving vibrating arms in the planar view.

5. The sensor element according to claim 3, wherein
a vibration direction of the detecting vibrating arm is a direction crossing a direction of the driving vibration.

6. The sensor element according to claim 1, wherein
the driving vibrating arms include a first driving vibrating arm, a second driving vibrating arm, a third driving vibrating arm, and a fourth driving vibrating arm,
the detecting vibrating arms include a first detecting vibrating arm and a second detecting vibrating arm,
defining two directions perpendicular to each other as a first direction and a second direction, the base includes a support part, a first connecting part and a second connecting part respectively extending from both sides of the support part along the second direction,
the first detecting vibrating arm and the second detecting vibrating arm respectively extend from both sides of the support part along the first direction,
the first driving vibrating arm and the second driving vibrating arm respectively extend from both sides of the first connecting part along the first direction, and
the third driving vibrating arm and the fourth driving vibrating arm respectively extend from both sides of the second connecting part along the first direction.

7. The sensor element according to claim 6, wherein
a direction of the driving vibration and a direction in which the detecting vibrating arm vibrates are each a direction along the second direction.

8. A method of manufacturing a sensor element, comprising: providing the sensor element including
a base,
a driving vibrating arm, which extends from the base, and has a first surface and a second surface located on an opposite side to the first surface, and
a detecting vibrating arm, which extends from the base, vibrates in accordance with a physical quantity applied to the driving vibrating arm, and has a third surface located on a same side as the first surface and a fourth surface located on an opposite side to the third surface,
wherein the driving vibrating arm has a bottomed groove on at least one of the first surface and the second surface, and
the detecting vibrating arm has a through hole penetrating the detecting vibrating arm in a direction crossing the third surface and the fourth surface;
preparing a substrate having an obverse surface and a reverse surface;
forming the base, the driving vibrating arm, the detecting vibrating arm, and the through hole by dry etching;
forming the bottomed groove by etching; and
forming an electrode pattern on at least one of an inner wall surface of the through hole and an inner surface of the bottomed groove.

9. The method according to claim 8, wherein
the forming the bottomed groove is performed after the forming the base, the driving vibrating arm, the detecting vibrating arm, and the through hole, and the etching in the forming the bottomed groove is performed by wet etching.

10. The method according to claim 8, wherein
the forming the base, the driving vibrating arm, the detecting vibrating arm, and the through hole is performed after the forming the bottomed groove, and the etching in the forming the bottomed groove is performed by dry etching.

11. A sensor comprising:
the sensor element according to claim 1;
an electronic component including a circuit adapted to drive the sensor element and a circuit adapted to detect a signal; and
a package adapted to house the sensor element and the electronic component.

12. A sensor comprising:
the sensor element according to claim 2;
an electronic component including a circuit adapted to drive the sensor element and a circuit adapted to detect a signal; and
a package adapted to house the sensor element and the electronic component.

13. A sensor comprising:
the sensor element according to claim 3;
an electronic component including a circuit adapted to drive the sensor element and a circuit adapted to detect a signal; and
a package adapted to house the sensor element and the electronic component.

14. A sensor comprising:
the sensor element according to claim 4;
an electronic component including a circuit adapted to drive the sensor element and a circuit adapted to detect a signal; and
a package adapted to house the sensor element and the electronic component.

15. An electronic apparatus comprising:
the sensor element according to claim 1.

16. An electronic apparatus comprising:
the sensor element according to claim 2.

17. An electronic apparatus comprising:
the sensor element according to claim 3.

18. A moving object comprising:
the sensor element according to claim 1.

19. A moving object comprising:
the sensor element according to claim 2.

20. A moving object comprising:
the sensor element according to claim 3.
